(19) United States
(12) Patent Application Publication
(10) Pub. No.: US 2005/0058358 A1
(43) Pub. Date: Mar. 17, 2005

(54) Method for planar processing of wavelet zero-tree data

(76) Inventors: Joseph R. Zbiciak, Arunston, TX (US); Jagadeesh Sankaran, Allen, TX (US)

Correspondence Address: TEXAS INSTRUMENTS INCORPORATED, P O BOX 655474, M/S 3999, DALLAS, TX, 75265, US

(21) Appl. No.: 10/883,872

(22) Filed: Jul. 2, 2004

Related U.S. Application Data
(60) Provisional application No. 60/484,361, filed on Jul. 2, 2003.
(60) Provisional application No. 60/484,395, filed on Jul. 2, 2003.

(51) Int. Cl. G06K 9/36

(52) U.S. Cl. 382/240

(57) ABSTRACT

This invention is a method of embedded zero-tree wavelet encoding that operates on planarized wavelet coefficient data. Following wavelet transformation of image data, the wavelet coefficients are transformed into bit plane form. The threshold comparisons are thus converted into determination whether a corresponding bit in a bit plane data word corresponding to the threshold is “1” or “0”. The reduction of the threshold occurs by consideration of the bit plane data for the next most significant bit. Zero-tree node determinations are made by a bottom up ANDing of the bits for all descendant wavelet coefficients. This technique makes better use of memory bandwidth, cache and data processing capability by operating on only the needed data.

### CLAIM OF PRIORITY

This application claims priority under 35 U.S.C. 119 (e) (1) from U.S. Provisional Application No. 60/484,361 and U.S. Provisional Application No. 60/484,395 both filed Jul. 2, 2003.

### TECHNICAL FIELD OF THE INVENTION

The technical field of this invention is wavelet encoding.

### BACKGROUND OF THE INVENTION

Wavelet encoding of image data transforms the image from a pixel spatial domain into a mixed frequency and spatial domain. In the case of image data the wavelet transformation includes two dimensional coefficients of frequency and scale. FIGS. 11 to 14 illustrate the basic technique of wavelet image transformation. The two dimensional array of pixels is analyzed X and Y directions and a set for transformed data that can be plotted in respective X and Y frequency. FIG. 15 illustrates transformed data 200 with the upper left corner the origin of the X and Y frequency coordinates. This transformed data is divided into four quadrant subbands. Quadrant 201 includes low frequency X data and low frequency Y data denoted as LL. Quadrant 202 includes low frequency X data and high frequency Y data denoted LH. Quadrant 203 includes high frequency X data and low frequency Y data denoted HL. Quadrant 204 includes high frequency X data and high frequency Y data denoted HH.

Organizing the image data in this fashion with a wavelet transform permits exploitation of the image characteristics for data compression. It is found that most of the energy of the data is located in the low frequency bands. The image energy spectrum generally decays with increasing frequency. The high frequency data contributes primarily to image sharpness. When describing the contribution of the low frequency components the frequency specification is most important. When describing the contribution of the high frequency components the time or spatial location is most important. The energy distribution of the image data may be further exploited by dividing quadrant 201 into smaller bands. FIG. 16 illustrates this division. Quadrant 201 is divided into subquadrant 211 denoted LLLL, subquadrant 212 denoted LLLH, subquadrant 213 denoted LLHL and subquadrant 214 denoted LLHH. As before, most of the energy of quadrant 201 is found in subquadrant 211. FIG. 17 illustrates a third level division of subquadrant 211 into subquadrant 221 denoted LLLLLL, subquadrant 222 denoted LLLLLH, subquadrant 223 denoted LLLLHL and subquadrant 224 denoted LLLLHH. FIG. 18 illustrates a fourth level division of subquadrant 221 into subquadrants 231 denoted LLLLLLLL, subquadrant 232 denoted LLLLLLLH, subquadrant 233 denoted LLLLLLHL and subquadrant 234 denoted LLLLLLHH.

For an n-level decomposition of the image, the lower levels of decomposition correspond to higher frequency subbands. Level one represents the finest level of resolution. The n-th level decomposition represents the coarsest resolution. Moving from higher levels of decomposition to lower levels corresponding to moving from lower resolution to higher resolution, the energy content generally decreases. If the energy content of level of decomposition is low, then the energy content of lower levels of decomposition for corresponding spatial areas will generally be smaller. There are spatial similarities across subbands. A direct approach to use this feature of the wavelet coefficients is to transmit wavelet coefficients in decreasing magnitude order. This would also require transmission of the position of each transmitted wavelet coefficient to permit reconstruction of the wavelet table at the decoder. A better approach compares each wavelet coefficient with a threshold and transmits whether the wavelet value is larger or smaller than the threshold. Transmission of the threshold to the detector permits reconstruction of the original wavelet table. Following a first pass, the threshold is lowered and the comparison repeated. This comparison process is repeated with decreasing thresholds until the threshold is smaller than the smallest wavelet coefficient to be transmitted. Additional improvements are achieved by scanning the wavelet table in a known order, with a known series of thresholds. Using decreasing powers of two seems natural for the threshold values.

These properties of the wavelet transformed image are exploited for data compression by an algorithm called embedded zero-tree wavelet coding introduced in Shapiro, J, “Embedded image coding using zerotrees of wavelet coefficients,” IEEE Transactions on Signal Processing, December 1993; vol. 41, no. 12, pp. 3445-3462. Natural images generally have a low pass spectrum. Wavelet encoded images have decreased energy as the scale decreases and resolution increases. Thus wavelet coefficients generally decrease for increasing frequency. Higher subbands of wavelet coefficients add only detail to the image, thus progressive encoding can be advantageous. Also, large wavelet coefficients are more important to the image reconstruction than small wavelet coefficients.

Embedded zero-tree wavelet (EZW) encoding exploits both the frequency energy character of natural images and the spatial dependency across decomposition levels. Wavelet coefficients are encoded in progressive passes starting with the highest coefficients. For each pass the wavelet coefficients are compared with a threshold. Those coefficients greater than the threshold are encoded and removed from the image data. Coefficients less than the threshold are skipped and left for a next pass. Once all the wavelet coefficients have been considered in a pass, then the threshold is lowered and all the wavelet coefficients are considered again against the lowered threshold. This process in repeated in discrete passes through the wavelet coefficient data until all wavelet coefficients are encoder or some other criteria is satisfied. In many cases this other criteria is a maximum data rate. Because this progressive encoding naturally considers more significant wavelet coefficients before less significant wavelet coefficients, truncating the encoding process at the end of a pass results in a near optimal encoding for that data rate. This algorithm uses zero-tree encoding to exploit the dependency of wavelet coefficients across differing scales (decomposition levels).

FIG. 19 illustrates scale dependency of wavelet coefficients. Each wavelet coefficient has a set of four analogs in a next lower level. In FIG. 19, wavelet coefficients B, C and D are shown with corresponding quads B1, B2, B3, B4, C1, C2, C3, C4, D1, D2, D3 AND D4. Each of these wavelet coefficients has a corresponding quad in the next lower level. As shown in FIG. 19: wavelet coefficients B1, B2, B3 and B4 each have corresponding quads B1, B2, B3 and B4 in the next lower level; wavelet coefficient C2 has a corresponding quad C2; and wavelet coefficient D2 has a corresponding quad D2.

A zero-tree is a wavelet coefficient where the root and all the descendent nodes are less than the threshold value for the current pass. These nodes are coded as zero-trees that differ from nodes in which the wavelet coefficient is less than the threshold but one or more descendants are greater than the threshold. If the wavelet coefficients are scanned from the greatest to the least, because of the decay of wavelet coefficients with frequency there will be enough zero-trees that a special coding will reduce the total amount of data coded.

The manner of image embedded zero-tree wavelet encoding includes conversion of pixel data into wavelet data in the frequency bands as shown in FIGS. 15 to 19. Next each wavelet coefficient is compared with the first threshold. This first threshold is set relative to the maximum coefficient value in the image. A convenient starting threshold is the greatest power of 2 less than the maximum wavelet coefficient. This is given by t₀ in the equation:
t₀=2^{|log}^{₂}^{(MAX)|}

where: t₀ in the initial threshold value; MAX is the maximum wavelet coefficient; and |x| is the greatest integer in x. Listing 1 shows an example pseudo-C main coding loop.

Listing 1

| /* Main Coding Loop */ | |
|---|---|
| threshold = initial_threshold; | |
| do { | |
| | dominant_pass(image); |
| | subordinat_pass(image); |
| | threshold = threshold/2; |
| } | while (threshold > minimum_threshold); |

This algorithm includes a dominant pass also called a significance pass. This dominant pass scans the wavelet coefficients for the whole image and produces one of four symbols. Wavelet coefficients are expressed as signed numbers. If the wavelet coefficient is greater than the threshold, this is coded as P (positive). If the wavelet coefficient is less than the inverse threshold, this is coded as N (negative). If the coefficient is the root of a zero-tree, this is coded as T (zero-tree). If the coefficient is between the threshold and the inverse threshold but not the root of a zero-tree, this is coded as Z (isolated zero). A Z occurs when a larger coefficient is in the subtree. Determining whether a wavelet coefficient smaller than the threshold is a zero-tree root requires scanning the whole quad-tree. Some bookkeeping is required to keep track of coefficients already coded as zero-trees to prevent re-coding these coefficients. Generally the wavelet coefficients coded as either P or N are extracted and placed in a subordinate list. Their positions in the original wavelet table are replaced with zero to prevent coding on further passes. Listing 2 shows an example for the dominant pass.

Listing 2

```
/*  Dominant Pass  */
    initialize_fifo( );
    while (fifo_not_empty) {
        get_coded_ceofficient_from_fifo( );
        if coefficient was coded as P, N or Z then {
        code_next_scan_coefficient( );
        put_coded_coefficient_in_fifo( );
        if coefficient was coded as P or N then {
            add abs(coefficient) to subordinate list;
            set coefficient position to zero;
        }
    }
}
```

The fifo (first-in-first-out buffer) is used to keep track of identified zero-trees. The fifo initialization adds the first quad-tree root wavelet coefficients. The call to code_next_scan_coefficiento checks the next uncoded wavelet coefficient in the image using the scanning order and outputs a P, N, T or Z. After coding the coefficient is placed in the fifo, which then contains only coded coefficients. The final if instruction removes wavelet coefficients coded P or N from the image and places them in the subordinate list. Note that coding wavelet coefficients at the lowest levels as zero-trees makes sure the loop will always end.

An example of the subordinate pass is shown in Listing 3.

Listing 3

```
/*  Subordinate Pass  */
    subordinate_threshold = current_threshold/2;
    for all elements on subordinate list do {
    if (coefficient > subordinate_threshold) {
        output a one;
        coefficient = coefficient − subordinate_threshold;
    }
    else output a zero;
}
```

When using powers of 2 as the thresholds, this subordinate pass reduces to a few logical operations.

FIG. 20 illustrates an example Morton scanning order and a corresponding set of wavelet coefficients used in a coding example. The Morton scanning retains the same order for each 4 by 4 block in increasing scale. In the wavelet coefficient example H indicates the coefficient is greater than the threshold and L indicates the coefficient is less than the threshold. In the absence of zero-tree coding, the encoded data is “HHLH HLLH LLLL HLHL.” When zero-tree coding is used, the encoded data is “HHTH HLLH HLHL,” where the T indicates a zero-tree node. The scanning order for the first block and the zero-tree node coding for the third element permits omission of further coding of the third block.

Using embedded zero-tree wavelet encoding involves practical problems with data processing. Known algorithms for embedded zero-tree wavelet encoding make poor use of memory bandwidth. Each pass at a particular threshold ordinarily requires recall and comparison of the whole wavelet coefficient for each position on the wavelet table. This results in a lot of data movement. In addition, the typical image to be encoded would be larger than the data processor cache. Thus many slow main memory accesses would be required. Known embedded zero-tree wavelet encoding algorithms also fail to efficiently use the decision making capabilities of the data processor. Most of the data processing of dominant pass is comparison of wavelet coefficients with the threshold. A typical prior art algorithm would generate a single comparison per data processor cycle. Some data processors with so called multimedia extension instructions can pack plural wavelet coefficients into a single data word and separately perform the same computation on each part of the data word. Even using these techniques only about 2 to 4 comparisons can be performed per cycle of the data processor. Making these decisions and performing these encoding operations on a coefficient-by-coefficient can be very time consuming.

### SUMMARY OF THE INVENTION

This invention is a method of embedded zero-tree wavelet encoding that operates on planarized wavelet coefficient data. Following wavelet transformation of image data, the wavelet coefficients are transformed into bit plane form. The threshold comparisons are thus converted into determination whether a corresponding bit in a bit plane data word corresponding to the threshold is “1” or “0”. The reduction of the threshold occurs by consideration of the bit plane data for the next most significant bit. Zero-tree node determinations are made by a bottom up ANDing of the bits for all descendant wavelet coefficients. This technique makes better use of memory bandwidth, cache and data processing capability by operating on only the needed data.

This planarization approach allows many decisions to be made in parallel, while simultaneously reducing memory bandwidth requirements. Instead of deciding on a single-pixel basis, the code can make decisions for N bits in parallel, where N is governed by the width of the data processor data word.

### BRIEF DESCRIPTION OF THE DRAWINGS

These and other aspects of this invention are illustrated in the drawings, in which:

FIG. 1 illustrates the starting bit arrangement of a set of example pixels in four data words in an example of use of this invention;

FIG. 2 illustrates the data operation of a known instruction that packs the high bytes of the two half-words of two source operands into a destination operand;

FIG. 3 illustrates the data operation of a known instruction that packs the low bytes of the two half-words of two source operands into a destination operand;

FIG. 4 illustrates the results of the pack data instructions of the prior art illustrated in FIGS. 2 and 3 as used in this invention on the data illustrated in FIG. 1;

FIG. 5 illustrates the operation of a shuffle instruction of the prior art used in this invention;

FIG. 6 illustrates the pixel arrangement of four data words of the example of this invention following a first shuffle operation;

FIG. 7 illustrates the pixel arrangement of four data words of the example of this invention following a second shuffle operation;

FIG. 8 illustrates the pixel arrangement of eight data words of the example of this invention following a masking arrangement;

FIG. 9 illustrates the pixel arrangement of four data words of the example of this invention following a shift operation;

FIG. 10 illustrates the pixel arrangement of four data words of the example of this invention at the completion of this invention;

FIG. 11 illustrates the data operation of a known instruction that packs the high half-words of two source operands into a destination operand;

FIG. 12 illustrates the data operation of a known instruction that packs the low half-words of two source operands into a destination operand;

FIG. 13 illustrates the data operation of a known instruction that swaps bytes of respective half-words of one source operand into a destination operand;

FIG. 14 is flow chart of the process of converting pixel data into bit plane data in accordance with this invention; and

FIG. 15 illustrates transformed wavelet data divided into four quadrant subbands;

FIG. 16 illustrates further division of quadrant 201 into smaller bands;

FIG. 17 illustrates a third level division of subquadrant 211 into yet smaller bands;

FIG. 18 illustrates a fourth level division of subquadrant 221 into still smaller bands;

FIG. 19 illustrates scale dependency of wavelet coefficients;

FIG. 20 illustrates an example Morton scanning order and a corresponding set of wavelet coefficients used in a coding example;

FIG. 21 illustrates an example of the type of data processing that occurs during a significance pass; and

FIG. 22 is a flow chart illustrating the method of this invention for image embedded zero-tree wavelet encoding.

### DETAILED DESCRIPTION OF PREFERRED EMBODIMENTS

This invention uses sequence of pack, bitwise-shuffle, masking, rotate and merging operations available on a Texas Instruments TMS320C6400 digital signal processor to transform a 16-bit by 16-bit tile from pixel form to bit plane form at a rate of 1 tile in 12 instruction cycles. This is equivalent to planarizing sixteen 16-bit bins. Due to minor changes in memory addressing, full planarization requires approximately 14 cycles for an equivalent amount of data.

This application will illustrate an example of planarizing 16-bit data. Although this example operates on 16-bit data, the algorithm can be modified to work with smaller or larger data sizes. The most common pixel data sizes are 8-bit and 16-bit. The following includes a description of the algorithm together with unscheduled code for an inner loop. This example code is correct except it omits the initial read of data into the registers and the final write out of the transformed data from the registers to memory. The example code uses mnemonics for the registers. These must be changed to actual, physical registers for scheduled code. One skilled in the art of digital signal processor programming would understand how to produce actual, scheduled code for a particular digital signal processor from this description.

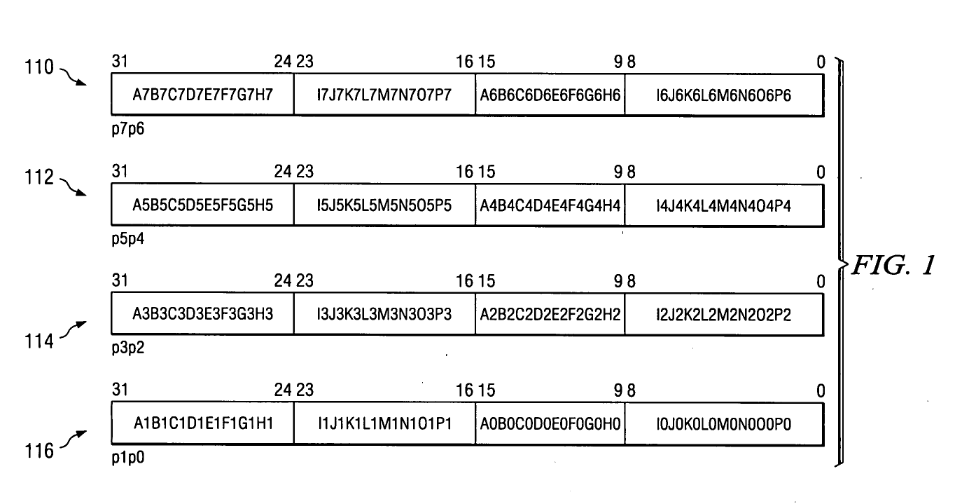

This invention converts packed pixels in normal format into packed data with the bit planes exposed. This invention will be described with an example beginning with 8 pixels p7 to p0. These eight pixels each have 16 bits A through P. FIG. 1 illustrates the initial configuration of pixels p7 to p0 in four 32-bit data words. The 16 bits of pixel p7 are packed into the 16 most significant bits of data word 110 (p7p6). The 16 bits of pixel p6 are packed into the 16 least significant bits of data word 110 (p7p6). Pixels p5 and p4 are packed into respective upper and lower halves of data word 112 (p5p4). Pixels p3 and p2 are packed into respective upper and lower halves of data word 114 (p3p2). Pixels p1 and p0 are packed into respective upper and lower halves of data word 116 (p1p0).

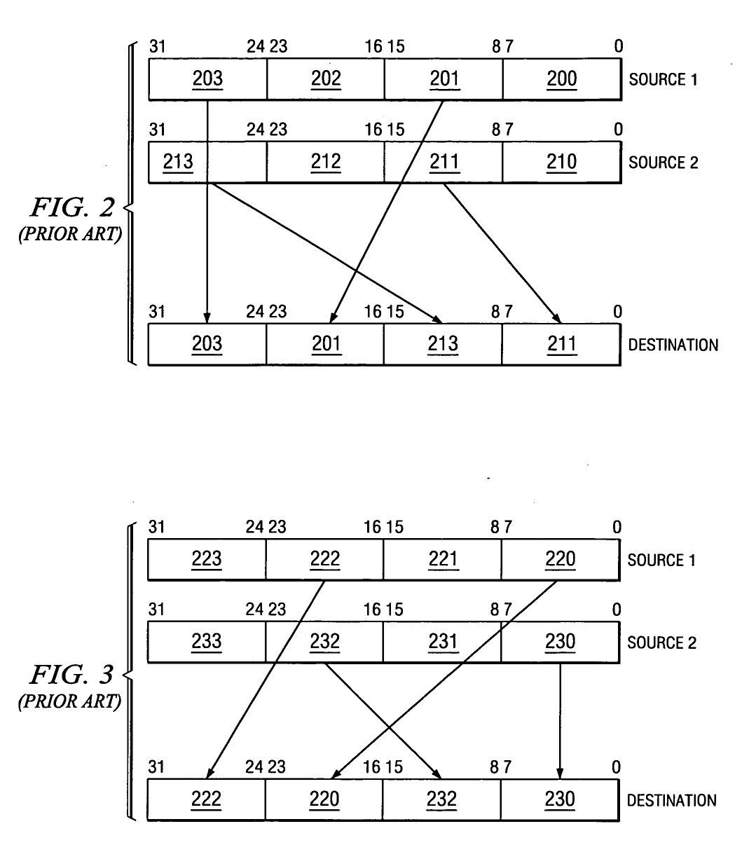

FIGS. 2 and 3 illustrate two known data manipulation instructions used in this invention. These instructions are available on the Texas Instruments TMS320C6400 family of digital signal processors. FIG. 2 illustrates an instruction called PACKH4 or pack high in four parts. As illustrated in FIG. 2, this instruction takes the upper byte (8 bits) from each 16-bit word of the two source operands source1 and source2 and stores them in respective bites of the destination operand. Specifically, the high byte 203 of the upper half-word of source1 is moved to the upper byte of the upper half-word of the destination. The high byte 201 of the lower half-word of source1 is moved to the lower byte of the upper half-word of the destination. The high byte 213 of the upper half-word of source2 is moved to the upper byte of the lower half-word of the destination. The high byte 211 of the lower half-word of source2 is moved to the lower byte of the lower half-word of the destination.

FIG. 3 illustrates an instruction called PACKL4 or pack low in four parts. The low byte 222 of the upper half-word of source1 is moved to the upper byte of the upper half-word of the destination. The low byte 220 of the lower half-word of source1 is moved to the lower byte of the upper half-word of the destination. The low byte 232 of the upper half-word of source2 is moved to the upper byte of the lower half-word of the destination. The low byte 230 of the lower half-word of source2 is moved to the lower byte of the lower half-word of the destination.

The planarization applies these two instructions to the four starting registers as follows:

| | |
|---|---|
| PACKH4 | p7p6, p5p4, p7654H |
| PACKL4 | p7p6, p5p4, p7654L |
| PACKH4 | p3p2, plp0, p3210H |
| PACKL4 | p3p2, plp0, p3210l |

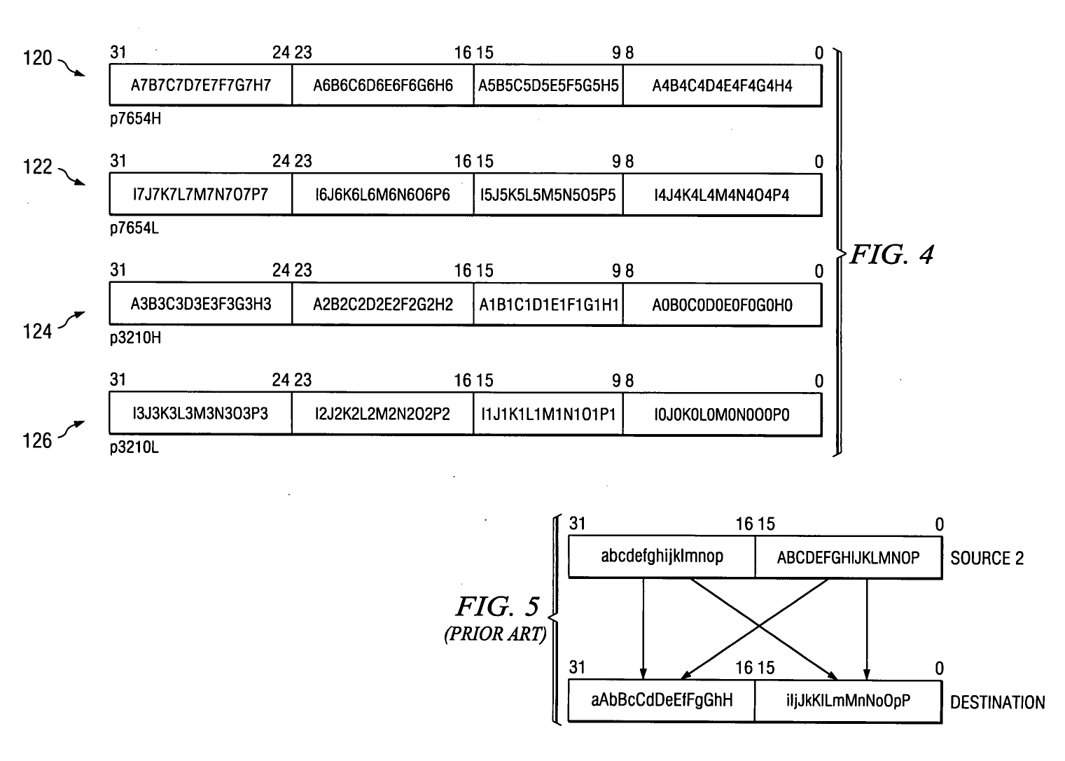

Thus each pair of registers is transformed into another pair of registers. The data of each pair of initial registers in included in the corresponding destination pair of registers. FIG. 4 illustrates the results of applying these four instructions to the four registers of FIG. 1. Data word 120 includes the first 8 bits (A to H) of pixels 4 to 7. Data word 122 includes the last 8 bits (I to P) of pixels 4 to 7. Data word 124 includes the first 8 bits (A to H) of pixels 0 to 3. Data word 126 includes the last 8 bits (I to P) of pixels 0 to 3.

The algorithm next uses a shuffle instruction. FIG. 5 illustrates the operation of this shuffle instruction. This resembles the shuffling of a deck of cards as the 16 most significant bits of a single operand register source2 are interleaved with the 16 least significant bits of this register into the destination register. All bits of the original source2 register appear in the destination register with a different bit order. Each of the four registers is shuffled using this instruction as follows:

| | |
|---|---|
| SHFL | p7654H, p7654H1 |
| SHFL | p7654L, p7654L1 |
| SHFL | p3210H, p3210H1 |
| SHFL | p3210L, p3210L1 |

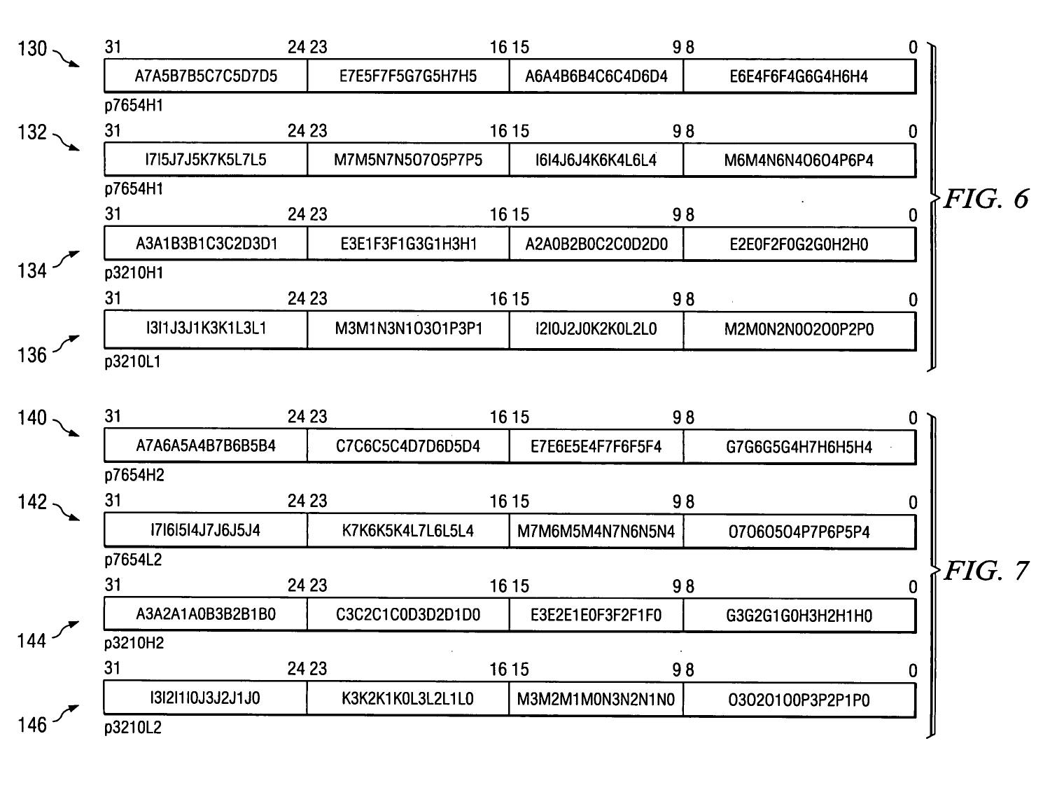

FIG. 6 illustrates the results of shuffling the four data word 120, 122, 124 and 126 resulting in respective data words 130, 132, 134 and 136. These four intermediate registers are shuffled again using the same instruction as follows:

| | |
|---|---|
| SHFL | p7654H1, p7654H2 |
| SHFL | p7654L1, p7654L2 |
| SHFL | p3210Hl, p3210H2 |
| SHFL | p3210L1, p3210L2 |

FIG. 7 illustrates the results of this second shuffle operation of data words 130, 132, 143 and 136 resulting in respective data words 140, 142, 144 and 146. As shown in FIG. 7 the data for the individual planes (A, B, C, D, E, F, G, H, I, J, K, L, M, N, O and P) are mostly together but in upper pixels p7 to p4 and lower pixels p3 to p0. Each of these four registers is then masked twice to produce eight intermediate register results. The first masking is accomplished with a logical AND instruction between the intermediate register and a constant mF0F0. This constant “11110000111100001111” is doubled to fill the 32 bits of the arithmetic logic unit. The second masking is accomplished with a logical ANDN instruction which uses the logical inverse of the constant mF0F0. These instructions are as follows:

| | |
|---|---|
| AND | p7654H2, mF0F0, p7654_ACEG |
| ANDN | p7654H2, mF0F0, p7654_BDFH_{—} |
| AND | p7654L2, mF0F0, p7654_IKMO |
| ANDN | p7654L2, mF0F0, p7654_JLNP_{—} |
| AND | p3210H2, mF0F0, p3210_ACEG_{—} |
| ANDN | p3210H2, mF0F0, p3210_BDFH |
| AND | p3210L2, mF0F0, p3210_IKNO_{—} |
| ANDN | p3210L2, mF0F0, p3210_JLNP |

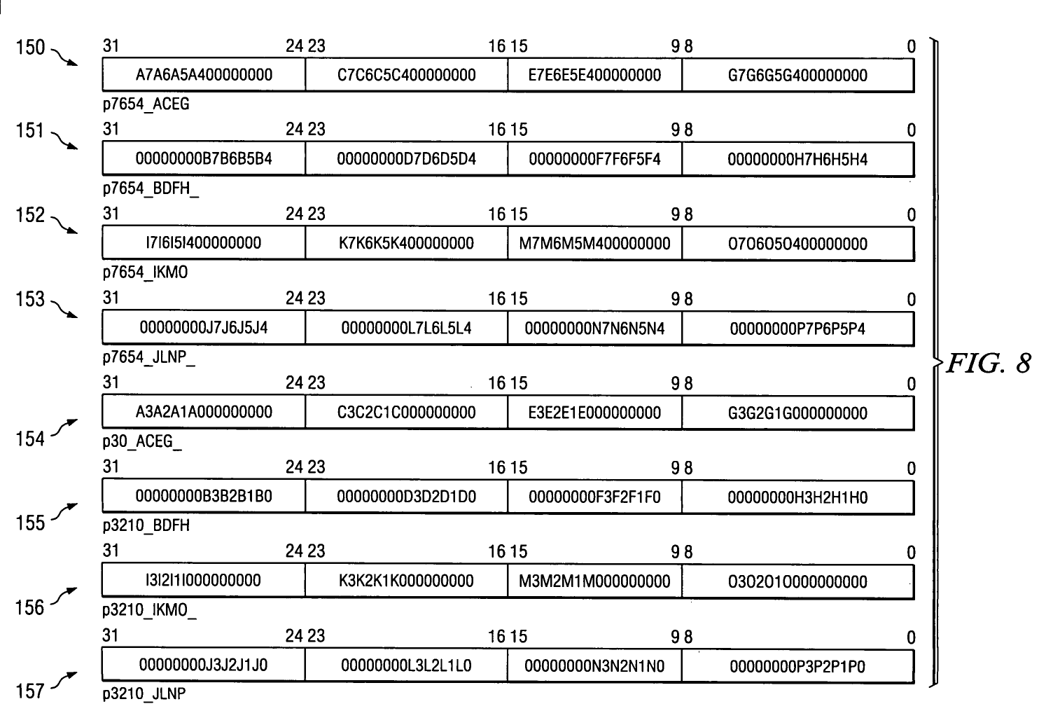

FIG. 8 illustrates the results of these masking instructions in data words 150, 151, 152, 153, 154, 155, 156 and 157. Note that: data word 140 is masked twice producing data words 150 and 151; data word 142 is masked twice producing data words 152 and 153; data word 144 is masked twice producing data words 154 and 155; and data word 146 is masked twice producing data words 156 and 157. Each four bit plane bits are now isolated within an 8-bit quarter of the data word. Half of these data words are shifted to align with the “0” bits of a corresponding data word. Two data words are right shifted four bits (SHRU) with the “U” indicating unsigned data so that the vacated bits are zero filled and two data words are left shifted four bits (SHL) with the vacated bits zero filled as follows:

| | |
|---|---|
| SHRU | p3210_ACEG_, 4, p3210_ACEG |
| SHL | p7654_SDFH_, 4, p7654_BDFH |
| SHRU | p3210_IKLO_, 4, p3210_IKMO |
| SHL | p7654_JLNP_, 4, p7654_JLNP |

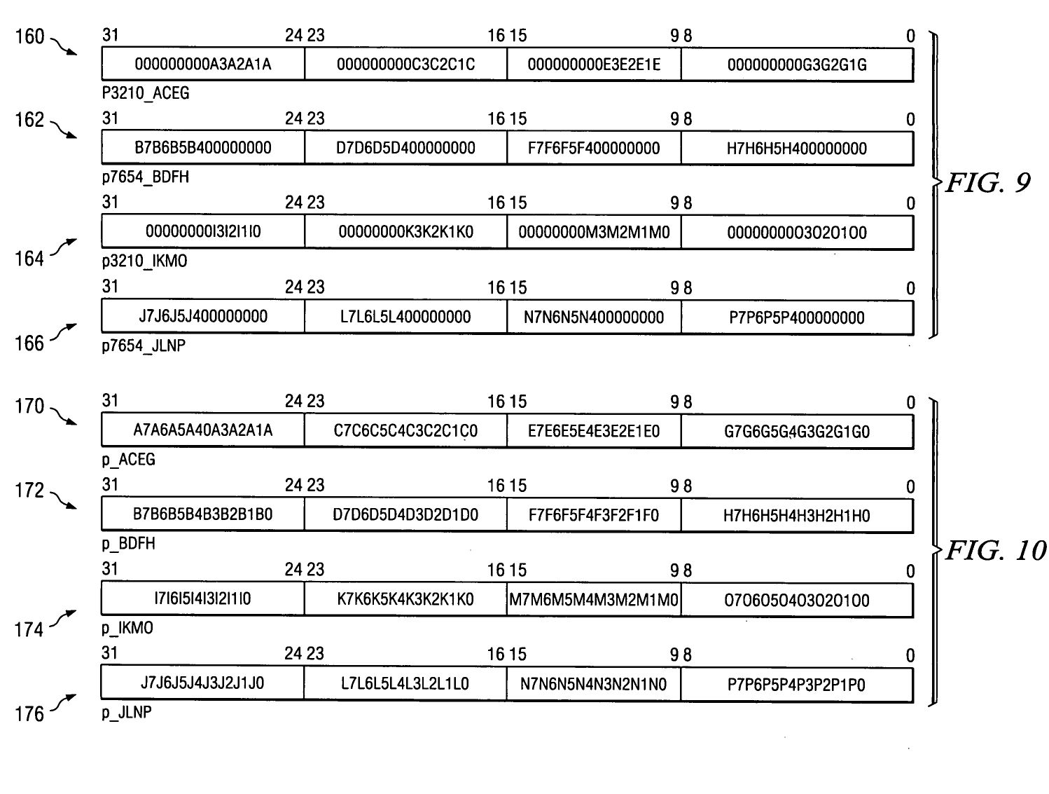

The four results of the shift operations are illustrated in FIG. 9 as data words 160, 162, 164 and 166. Data word 154 is right shifted 4 bits to become data word 160. Data word 151 is left shifted 4 bits to become data word 162. Data word 156 is right shifted 4 bits to become data word 164. Data word 153 is right shifted 4 bits to become data word 166. The pixel data for each bit plane are now in position for combining. Four data words 150, 152, 154 and 156 shown in FIG. 8 are combined with corresponding data words 160, 162, 164 and 166 shown in FIG. 9 as follows:

| | |
|---|---|
| ADD | p7654_ACEG, p3210_ACEG, p_ACEG |
| ADD | p7654_BDFH, p3210_BDFH, p_BDFH |
| ADD | p7654_IKMO, p3210_IKMO, p_IKMO |
| ADD | p7654_JLNP, p3210_JLNP, p_JLNP |

FIG. 10 illustrates the results of these ADD instructions as data words 170, 172, 174 and 176. Because the masking places zeros of one operand opposite the data of the other operand, the result is combination of the data. A bit wise logical OR operation would also form this same combination.

As shown in FIG. 10 the result of these manipulations places the bit plane data for all pixels in contiguous locations. The plane bits are not in consecutive order, however, each bit plane is easily extracted. Data word 170 includes bit planes A, C, E and G. Data word 172 includes bit planes B, D, F and H. Data word 174 includes bit planes I, K, M and O. Data word 176 includes bit planes J, L, N and P.

The listing below incorporates the algorithm just described. This listing shows that the Texas Instruments TMS320C6400 digital signal processor can operate on 16 16-bit pixels packed into 8 32-bit data words simultaneously. This listing incorporates additional instructions of the TMS320C6400 digital signal processor that will be described below in the comments. The data registers are given “A” and “B” prefixes denoting the A and B register files with the corresponding execution units of the TMS320C6400. Comments in this listing explain the operation performed.

/* Loading 8 data words each with 16 packed pixels via four
* double word load instructions */

| | | |
|---|---|---|
| <1> | LDDW * A_i_ptr++[4], | B_p7p6:B_p5p4 |
| <1> | LDDW *-A_i_ptr[3], | B_p3p2:B_plp0 |
| <2> | LDDW * B_i_ptr++[4], | A_p7p6:A_p5p4 |
| <2> | LDDW *-B_i_ptr[3], | A_p3p2:A_plp0 |

/* First data swap by bytes */

| | |
|---|---|
| PACKH4 | B_p7p6, B_p5p4, B_p7654H |
| PACKL4 | B_p7p6, B_p5p4, B_p7654L |
| PACKH4 | B_p3p2, B_plp0, B_p3210H |
| PACKL4 | B_p3p2, B_plp0, B_p3210L |
| PACKH4 | A_p7p6, A_p5p4, A_p7654H |
| PACKL4 | A_p7p6, A_p5p4, A_p7654L |
| PACKH4 | A_p3p2, A_p1p0, A_p3210H |
| PACKL4 | A_p3p2, A_p1p0, A_p3210L |

/* First bit shuffle of each data word */

| | |
|---|---|
| SHFL | B_p7654H, B_p7654H1 |
| SHFL | B_p7654L, B_p7654L1 |
| SHFL | B_p3210H, B_p3210H1 |
| SHFL | B_p3210L, B_p3210L1 |
| SHFL | A_p7654H, A_p7654H1 |
| SHFL | A_p7654L, A_p7654L1 |
| SHFL | A_p3210H, A_p3210H1 |
| SHFL | A_p3210L, A_p3210L1 |

/* Second bit shuffle of each data word */

| | |
|---|---|
| SHFL | B_p7654H1, B_p7654H2 |
| SHFL | B_p7654L1, B_p7654L2 |
| SHFL | B_p3210Hl, B_p3210H2 |
| SHFL | B_p3210L1, B_p3210L2 |
| SHFL | A_p7654H1, A_p7654H2 |
| SHFL | A_p7654L1, A_p7654L2 |
| SHFL | A_p3210Hl, A_p3210H2 |
| SHFL | A_p3210L1, A_p3210L2 |

/* Masking nibbles to prepare for merge */

| | |
|---|---|
| AND | B_p7654H2, B_mF0F0, B_p7654_ACEG |
| ANDN | B_p7654H2, B_mF0F0, B_p7654_BDFH_{—} |
| AND | B_p7654L2, B_mF0F0, B_p7654_IKMO |
| ANDN | B_p7654L2, B_mF0F0, B_p7654_JLNP_{—} |
| AND | B_p3210H2, B_mF0F0, B_p3210_ACEG_{—} |
| ANDN | B_p3210H2, B_mF0F0, B_p3210_BDFH |
| AND | B_p3210L2, B_mF0F0, B_p3210_IKMO_{—} |
| ANDN | B_p3210L2, B_mF0F0, B_p3210_JLNP |
| AND | A_p7654H2, A_mF0F0, A_p7654_ACEG |
| ANDN | A_p7654H2, A_mF0F0, A_p7654_BDFH_{—} |
| AND | A_p7654L2, A_mF0F0, A_p7654_IKMO |
| ANDN | A_p7654L2, A_mF0F0, A_p7654_JLNP_{—} |
| AND | A_p3210H2, A_mF0F0, A_p3210_ACEG_{—} |
| ANDN | A_p3210H2, A_mF0F0, A_p3210_BDFH |
| AND | A_p3210L2, A_mF0F0, A_p3210_IKMO_{—} |
| ANDN | A_p3210L2, A_mF0F0, A_p3210_JLNP |

/* Rotate half the data words to prepare for merge */

| | |
|---|---|
| ROTL | B_p3210_ACEG_, 28, B_p3210_ACEG |
| ROTL | B_p7654_BDFH_, 4, B_p7654_BDFH |
| ROTL | B_p3210_IKMO_, 28, B_p3210_IKMO |
| ROTL | B_p7654_JLNP_, 4, B_p7654_JLNP |
| ROTL | A_p3210_ACEG_, 28, A_p3210_ACEG |
| ROTL | A_p7654_BDFH_, 4, A_p7654_BDFH |
| ROTL | A_p3210_IKMO_, 28, A_p3210_IKMO |
| ROTL | A_p7654_JLNP_, 4, A_p7654_JLNP |

/* Merge of nibble data */

| | |
|---|---|
| ADD | B_p7654_ACEG, B_p3210_ACEG, B_p_ACEG |
| ADD | B_p7654_BDFH, B_p3210_ACEG, B_p_BDFH |
| ADD | B_p7654_IKMO, B_p3210_ACEG, B_p_IKMO |
| ADD | B_p7654_JLNP, B_p3210_ACEG, B_p_JLNP |
| ADD | A_p7654_ACEG, A_p3210_ACEG, A_p_ACEG |
| ADD | A_p7654_BDFH, A_p3210_ACEG, A_p_BDFH |
| ADD | A_p7654_IKMO, A_p3210_ACEG, A_p_IKMO |
| ADD | A_p7654_JLNP, A_p3210_ACEG, A_p_JLNP |

/* Word (16 bit) shuffle to order bit plane data */

| | |
|---|---|
| PACKH2 | B_p_ACEG, A_p_ACEG, B_ACAC |
| PACK2 | B_p_ACEG, A_p_ACED, B_EGEG |
| PACKH2 | B_p_BDFH, A_p_BDFH, B_BDBD |
| PACK2 | B_p_BDFH, A_p_BDFH, B_FHFH |
| PACKH2 | A_p_IKNO, B_p_IKMO, A_IKIK_{—} |
| PACK2 | A_p_IKNO, B_p_IKMO, A_MOMO_{—} |
| PACKH2 | A_p_JLNP, B_p_JLNP, A_JLJL_{—} |
| PACK2 | A_p_JLNP, B_p_JLNP, A_NPNP_{—} |

/* Byte (8 bit) shuffle to order bit plane data */

| | |
|---|---|
| PACKH4 | B_ACAC, B_BDBD, B_AABB |
| PACKL4 | B_ACAC, B_BDBD, B_CCDD |
| PACKH4 | B_EGEG, B_FHFH, B_EEFF |
| PACKL4 | B_EGEG, B_FHFH, B_GGHH |
| PACKH4 | A_IKIK, A_JLJL_, A_IIJJ_{—} |
| PACKL4 | A_IKIK, A_JLJL_, A_KKLL_{—} |
| PACKH4 | A_MOMO_, A_NPNP_, A_MNNN_{—} |
| PACKL4 | A_MOMO_, A_NPNP_, A_OOPP_{—} |

/* Byte (8 bit) exchange to order bit planes */

| | |
|---|---|
| SWAP4 | A_IIJJ, A_IIJJ |
| SWAP4 | A_KKLL_, A_KKLL |
| SWAP4 | A_MMNN_, B_MMNN |
| SWAP4 | A_OOPP_, B_OOPP |

/* Storing 8 data words with 16 packed bit planes via four
* double word store instructions */

| | | |
|---|---|---|
| <3> | STDW B_AABB:B_CCDD, | *+B_o_ptr[0] |
| <3> | STDW B_EEFF:B_GGHH, | *+B_o_ptr[1] |
| <3> | STDW A_IIJJ:A_KKLL, | *+B_o_ptr[2] |
| <3> | STDW B_MMNN:B_OOPP | *+B_o_ptr[3] |

This code uses rotate instructions RDTL rather than shift right unsigned (SHRU) and shift left (SHL) of the previous example. The RDTL by 28 bits corresponds to the shift right unsigned SHRU by 4 bits. The RDTL by 4 bits corresponds to the shift left SHL by 4 bits. Thus any instruction shifts the input data left and/or right by 4 bits without sign extension will work.

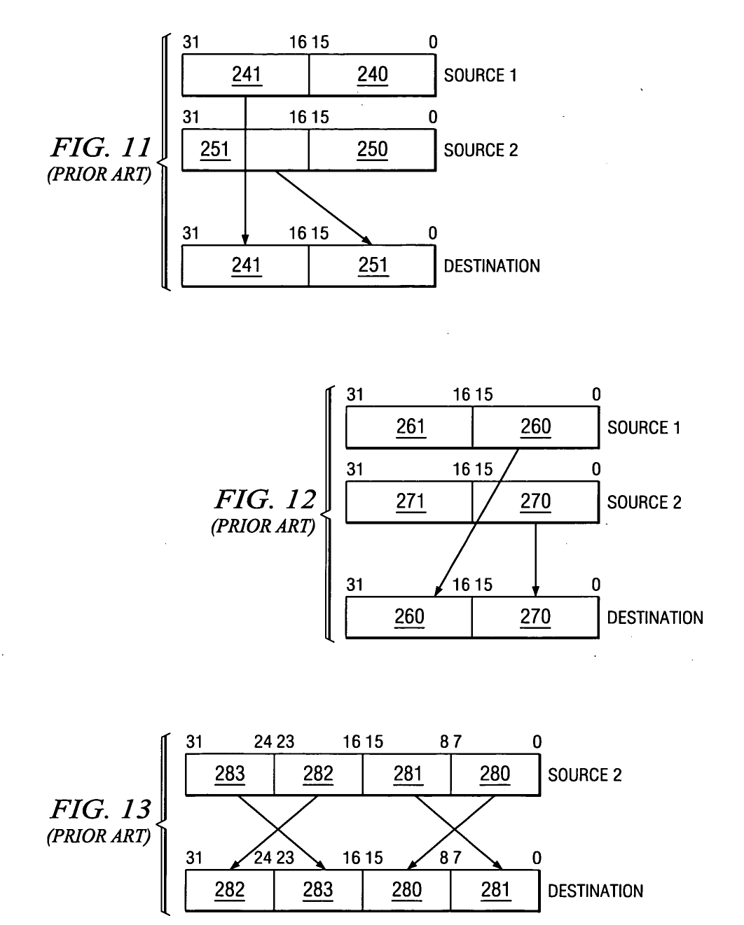

The PACKH2 and PACK2 instructions are similar to the PACKH4 and PACK4 instructions except that they operate on data words (16 bits) rather than bytes. FIG. 11 illustrates the operation of the pack high words PACKH2 instruction. The high words (16 bits) of each source operand are packed into the destination. High word 241 of the first source operand source1 becomes the high word of the destination operand. High word 251 of the second source operand source2 becomes the low word of the destination operand. FIG. 12 illustrates the operation of the pack low words PACK2 instruction. The low words (16 bits) of each source operand are packed into the destination. Low word 260 of the first source operand source1 becomes the high word of the destination operand. Low word 270 of the second source operand source2 becomes the low word of the destination operand.

FIG. 13 illustrates the operation of the swap bytes in each half word instruction SWAP4. As illustrated in FIG. 13, this instruction swaps the upper byte (8 bits) with the lower byte (8 bits) of each 16-bit word of the second source operand source2. Specifically, the high byte 243 of the upper half-word of source2 is moved to the lower byte of the upper half-word of the destination. The low byte 242 of the upper half-word of source2 is moved to the upper byte of the upper half-word of the destination. The high byte 241 of the lower half-word of source2 is moved to the upper byte of the lower half-word of the destination. The low byte 241 of the lower half-word of source2 is moved to the lower byte of the lower half-word of the destination.

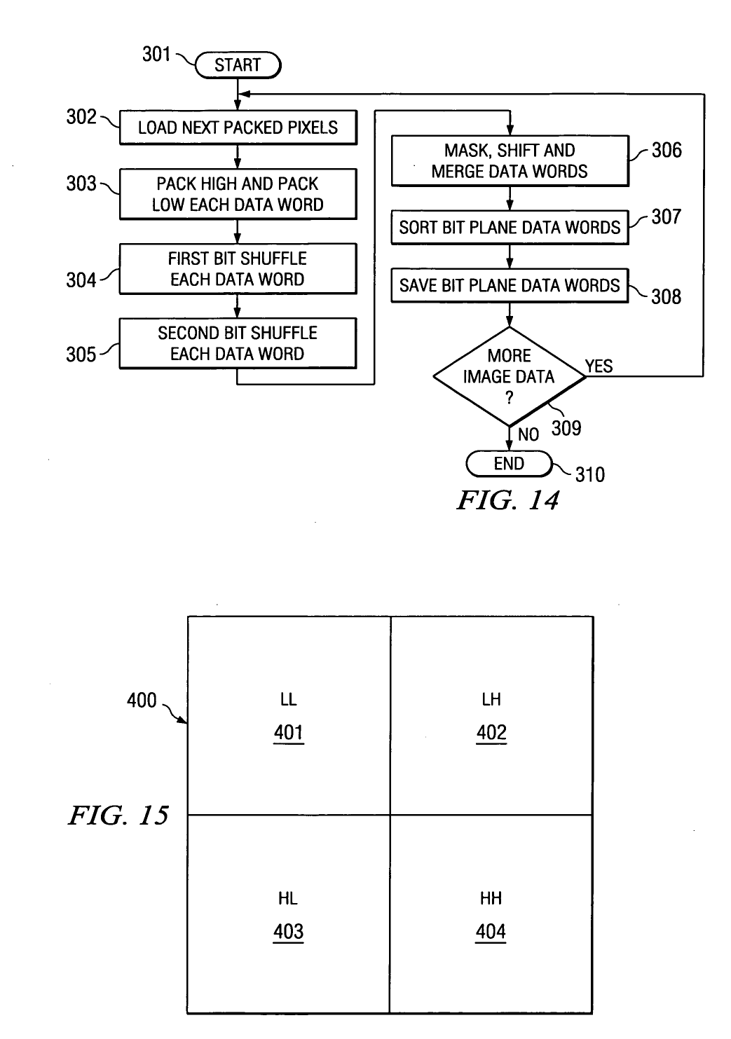

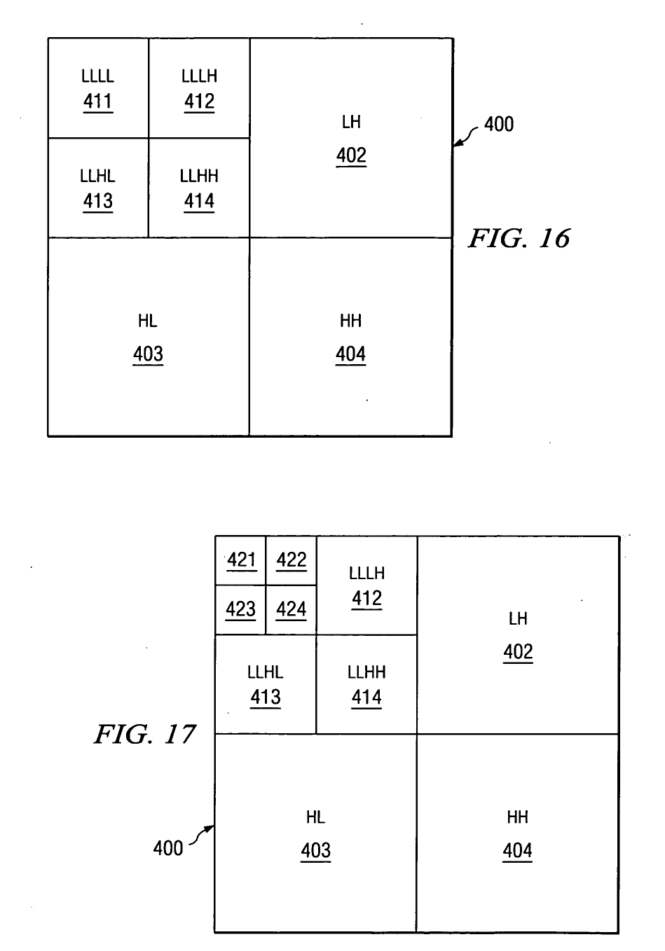

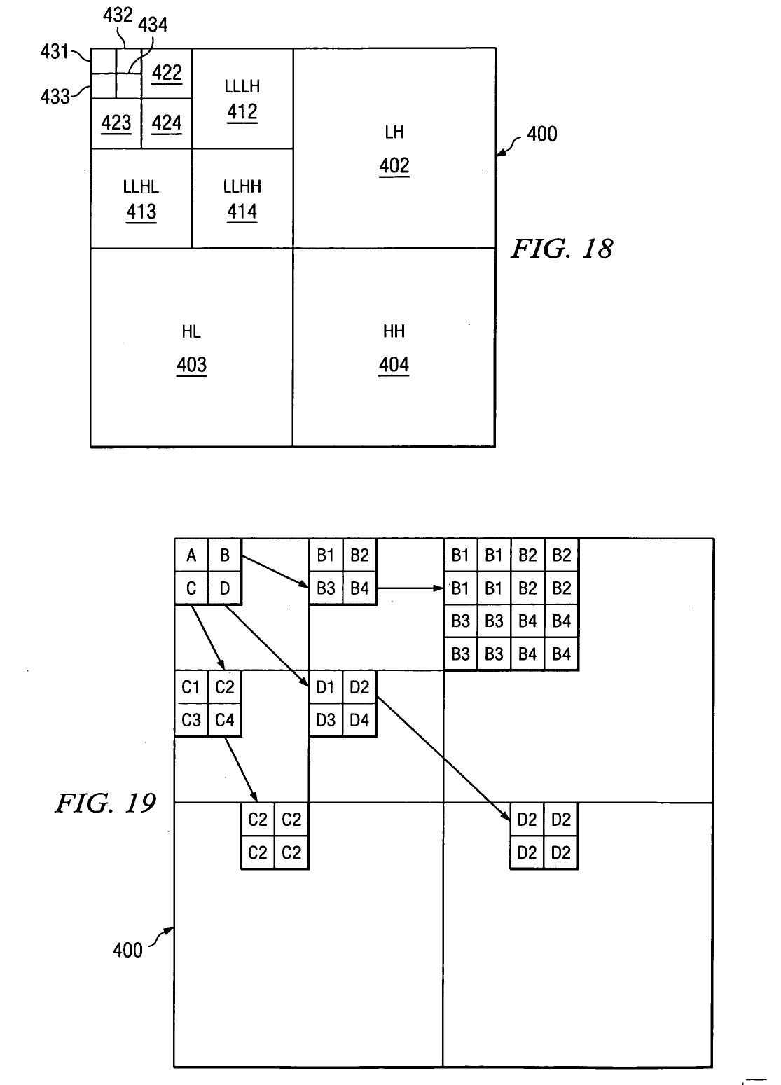

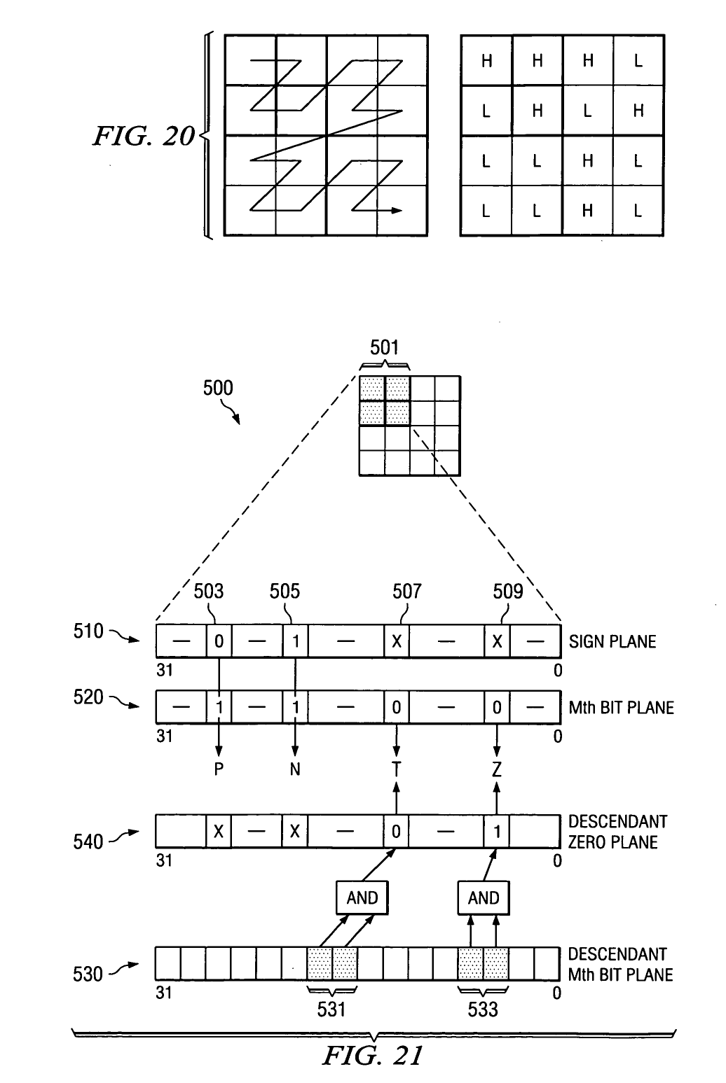

FIG. 14 illustrates the process of converting pixel data into bit plane data. The process begins at start block 301. The process loads the next set of packed pixels (processing block 302). The number of packed pixel data words loaded depends on the register capacity of the data processing apparatus and the relationship between the pixel bit length and the data word length. In the previous examples, there are two 16-bit pixels packed into each 32 bit data word and the apparatus loads 4 or 8 of these packed data words. Next each data word is shuffled via a pack high and a pack low instruction (processing block 303). The data width of the shuffled part is half the data width of the pixel data. The process subjects resulting data words to a first bit shuffle (processing block 304) and a second bit shuffle (processing block 305). The bit shuffle was described above in conjunction with FIG. 5. The process next masks, shits and merges the shuffled data words (processing block 307). The mask size corresponds to one quarter of the original pixel data length. In the examples of this application the mask length is four bits. The masking of this example is used because the target data processor (Texas Instruments TMS320C6400) does not have a set of pack instructions having 4-bit length. If such an instruction was available, it could be used here rather than the mask, shift and merge operations described above. The process next sorts the bit plane data words (processing block 307). Recall the original example produced bit plane data that was not sorted in the bit order (FIG. 10). The second example shows how this bit plane data can be sorted into order from most significant to least significant bit planes. Decision block 309 determines if there is additional image data to be converted. If not (No at decision block 309), the process is complete and exits via end block 310. If there is additional image data (Yes at decision block 309), the control returns to processing block 302 to load the next pixel data.

The bitwise shuffle instruction SHFL allows effective sort of the bit-planes in parallel. This achieves very high efficiency. The prior art approach employs the fundamentally information-losing activity of extracting one bit of interest and discarding the rest. Thus the prior art produces much greater memory traffic. This invention moves all the bits together. In each step all bits move closer to their final destination. As a result, this invention can corner turn or planarize 256 bits in 12 cycles, for a rate of 21.33 bits/cycle. This is more than ten times faster than the estimated operational rate of the prior art approach.

Another prior art approach employs custom hardware to transpose the data and produce the desired bit plane data. This custom hardware requires silicon area not devoted to general purpose data processing operations. This results in additional cost in manufacture and design of the digital signal processor incorporating this custom hardware. Use of this custom hardware would also require additional programmer training and effort to learn the data processing performed by the custom hardware. In contrast, this invention employs known instructions executed by hardware which could be used in other general purpose data processing operations.

This technique is useful in many fields. The image data compression standards JPEG 2000 and MPEG4 both employ wavelet schemes that rely on zero-tree decomposition of the wavelets. These zero-tree schemes benefit from planarization of the data prior to processing. Pulse-modulated display devices, such as the Texas Instruments Digital Mirror Device (DMD) and various liquid crystal displays (LCD) often employ bit-plane-oriented display. In these processes one bit plane is sent to the display at a time and is held in the display for a time proportional to the bit's numeric value. These devices rely on corner-turning as a fundamental operation.

This invention exploits a bit plane view of the image wavelet coefficient data to greatly speed the required data processing. Bit plane data can be effectively used in the threshold comparisons in the dominant pass/significance pass, in the determination of whether a wavelet coefficient is the node of a zero-tree and in the subordinate pass/refinement pass. This invention relies on the efficient method of data planarization described above.

This invention starts by planarization of the whole image. In this invention, a single bit plane of a number of wavelet coefficients corresponding to the data processor word size are stored in a data word. In the preferred embodiment the process is implemented by a Texas Instruments TMS320C6400. This data processor operates on 32-bit data words. Therefore the data is planarized so that a single bit plane of 32 wavelet coefficients is stored in a single data word. The bit position within the data word and the memory location of the data word correspond to the position of the wavelet coefficient within the wavelet table. In this example the wavelet coefficient data is expressed in 16-bit signed integer notation. Thus the 15th bit plane is the sign bit of the wavelet coefficients. The 14th bit is the most significant bit of the wavelet coefficient.

This invention sets the thresholds corresponding to the individual bit planes. The initial threshold corresponds to the 14th bit plane, the most significant bit of the wavelet coefficients. When viewing the 14th bit plane of the wavelet coefficient data, bits that are “1” are significant, that is, the wavelet coefficients corresponding to these bits are above the threshold (positive) or below the inverse threshold (negative). The determination of whether the corresponding wavelet coefficient is positive or negative depends upon the state of the 15th bit plane, the sign bit. Bits that are “0” are not significant. The corresponding wavelet coefficients are either zero-tree nodes or isolated zeros. Once all the 14th bit plane of all wavelet coefficients have been considered and encoded P, N, T or Z, then the threshold is reduced by a power of 2. This is implemented by considering the next most significant bit plane data. These wavelet coefficients are encoded P, N, T or Z depending on the bit state in that bit plane. Thus this data organization permits consideration of 32 wavelet coefficients at a time in a 1-bit single instruction multiple data (SIMD) format.

This invention applies decision making criteria in the form of ANDs, ORs, XORs, shifts and other standard logical operations that operate on all 32 bits of the data word. This in effect causes decisions to be made for all M coefficients at once.

In addition, because this invention only reads the bit of interest, this reduces memory traffic by a corresponding factor. For M-bit data, the traffic and memory footprint is reduced by a factor of M. This gain is realized because the corresponding bit plane is all the data needed for the threshold determination and no additional data. For large images, this decrease in memory footprint brings its own gains. Consider a 256 by 256 image with 16-bit coefficients. This image requires 128K bytes of storage. However, one bit plane of this image requires only 8192 bytes of storage. While the former is likely many times larger than the available data cache, the latter could easily be within the size of the data cache. The result is much better cache utilization and a consequent faster data processing operation.

FIG. 21 illustrates an example of the type of data processing that occurs during a significance pass. Array 500 includes section 501. Sign plane 510 includes the sign bit plane for section 501. Mth bit plane 520 includes the Nth bit plane for section 501. FIG. 21 illustrates a significance pass for the Mth bit plane. Wavelet coefficient 503 is encoded P (positive) because the corresponding sign bit in sign bit plane 510 is “0” and the corresponding Mth bit in Mth bit plane 520 is “1”. Wavelet coefficient 503 is encoded N (negative) because the corresponding sign bit in sign bit plane 510 is “1” and the corresponding Mth bit in Mth bit plane 520 is “1”.

Encoding wavelet coefficients 507 and 509 does not depend of the sign bit, hence each corresponding sign bit in sign bit plane 510 is marked don't care “X”. Wavelet coefficient 507 is encoded as a zero-three node (T) because the corresponding Mth bit in Mth bit plane 520 is “0” and the corresponding bit in descendant zero plane 540 is also “0”. FIG. 21 schematically illustrates the derivation of ancestor zero plane 540. Bits 531 of the descendant Mth bit plane 530 correspond to the quad-tree descendants of wavelet coefficient 505. As illustrated schematically in FIG. 21, these Mth plane bits of the descendant wavelet coefficients are ANDed together. If all these bits are “0”, then the AND result is “0” as shown in FIG. 21. If any of these bits is “1”, then the AND result is “1” as shown for wavelet coefficient 509.

Not shown in FIG. 21 is a further layer of descendant wavelet coefficients which are the descendants of wavelet coefficients 531 and of wavelet coefficients 533. Descendant zero plane 540 includes an ANDing of all descendant wavelet coefficients of the corresponding coefficient to the first level of division (FIG. 15). This leads to a further advantage of this invention. In the prior art the determination of whether a zero wavelet coefficient is a zero-tree node is performed “top down” from the current wavelet coefficient. Upon detection of a wavelet coefficient below the current threshold, the prior art method inspects all descendant wavelet coefficients to determine if any are above the threshold. This process typically involves recalling all the descendant wavelet coefficients, comparing them with the current threshold and bookkeeping the results. This prior art process requires a lot of memory traffic and computational resources. The length of this process is generally data dependent because detection of a single descendant wavelet coefficient above the threshold could trigger an early exit from the zero-tree node determination.

This invention employs a “bottom up” technique. The locations of the wavelet coefficients of the current Mth bit plane 520 are known. These locations depend on the memory organization but are known. Additionally, the memory organization controls the storage location of the Mth bit plane data for all the descendants of the wavelet coefficients represented in Mth bit plane 530. The method of this invention ANDs all the Mth bits of the descendants of all 32 wavelet coefficients of Mth bit plane 520. The process preferably begins at the lowest level and proceeds upward to the level of the wavelet coefficients of Mth bit plane 520. The bit-SIMD approach of this invention lends itself to an efficient “bottom up” implementation that avoids recursion and runs in relatively fixed time. The following code exemplifies this improvement:

| /* Initial recursive portion of significance pass: Identify | |
|---|---|
| * non--zero subtrees. This pass is coded in a | |
| * non-recursive bottom-up fashion. */ | |
| void ezw_calc_nonzero_tree | |
| ( | |
| const unsigned *restrict bitmap, | |
| unsigned *restrict nztmap, | |
| int x_dim, | |
| int y_dim, | |
| int n_levels | |
| ) | |
| { | |
| int i, x, y, yo, io; | |
| int stride; | |
| _nassert((int)bitmap % 8 == 0); | |
| _nassert((int)nztmap % 8 == 0); | |
| _nassert(nlevels >= 1); | |
| _nassert(x_dim >= 64); | |
| _nassert(y_dim >= 64); | |
| _nassert(x_dim % 64 == 0); | |
| _nassert(y_dim % 64 == 0); | |
| stride = y_dim >> 5; | |
| io = (xdim >> n_levels) >> 5; | |
| yo = y_dim >> n_levels; | |
| memcpy(nztmap, bitmap, x_dim * y_dim >> 3); | |
| _nassert(stride % 2 == 0); | |
| /* first pass */ | |
| for (y = y_dim >> 1; y >= 0; y−−) | |
| { | |
| for (i = 0; 1 < stride >> 1; i++) | |
| { | |
| unsigned w0, wl, wr; | |
| w0 = | nztmap[(2*y + 0) * stride + 2*i+ 0] \| |
| | nztmap[(2*y + 1) * stride + 2*i + 0]; |
| wl = | nztmap[(2*y + 0) * stride + 2*i + 1] \| |
| | nztmap[(2*y + 1) * stride + 2*i + 1]; |
| wr = | _packh2(_deal(w0 \| (w0<<l)), |
| | _deal(wl \| (wl<<l))); |

```
            nztmap[y * stride + 1] = wr;
        }
    }
    /* second pass calculate truncated ‘hall-of-mirrors” in
      * upper left */
    for (y = 0; y < yo; y++)
        for (i = 0; i < stride >> nlevels; i++)
        {
            nztmap[ y * stride + i] =
```

bitmap[y * stride + 1 ]|
nztmap[(y + yo) * stride + i ]|
nztmap[ y * stride + i + io]|
nztmap[(y + yo) * stride + i + io];

}
}

Another example of the decision making capability of this invention is determining which bits to send during the significance pass and the refinement pass. This invention merges nztmap (Non-Zero Tree map) into the sigmap (Significant Bits map). Any bits that become set in sigmap will be set in newmap. These are bits that will be sent during the significance phase of the encoding. All the other significant coefficients will get their bits sent during the refinement pass.

| void ezw_calc_update_significant | |
|---|---|
| ( | |
| const unsigned | *restrict nztmap, |
| unsigned | *restrict sigmap, |
| unsigned | *restrict newmap, |

```
    int x_dim,
    int y_dim
)
{
    for (i = 0; i < v_dim * (xdim >> 5); i++)
    {
        newmap[i] = nztmap[i] & ˜sigmap[i];
        sigmap[i] = nztmap[i] | sigmap[i];
    }
}
```

These code snippets are merely examples. This invention permits parallel operation where it was not previously known. The resulting decision bitmaps can then be processed using left most bit detect (LMBD) or other approaches to efficiently scan for coefficients that need encoding.

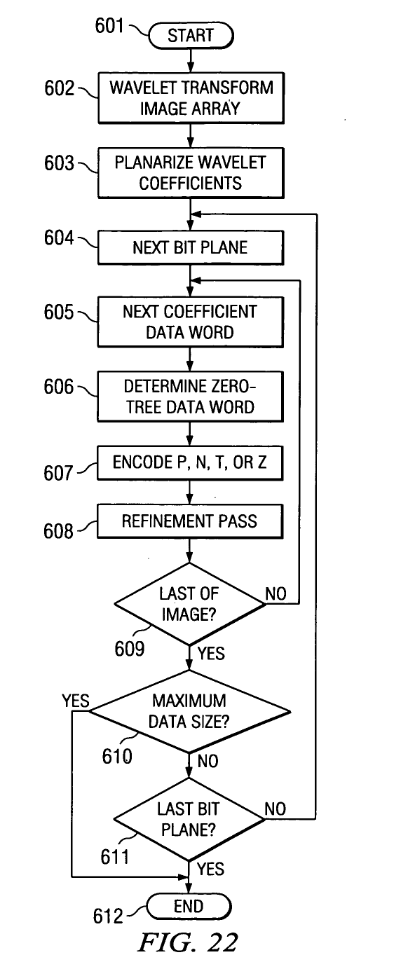

FIG. 22 is a flow chart illustrating the method of this invention for image embedded zero-tree wavelet encoding. The process begins with start block 601. The process first transform the image from spatial pixel data to wavelet transform data (processing block 602). This part of the encoding process is known in the art. The process transforms the wavelet coefficients for the whole image into bit plane form (processing block 603). This part of the process is described in conjunction with FIGS. 1 to 14 of this application. The bit plane data preferably has a single bit plane for plural pixels packed in each transformed data word as described above. The process considers the next bit plane (processing block 604) thereby setting the current threshold. On the first iteration of this loop, the next bit plane is the most significant non-sign bit. On each succeeding iteration, the next bit plane is the next most significant bit. The process considers the next wavelet coefficient data word (processing block 605). This next wavelet coefficient data word corresponds to a portion of the image as illustrated in FIG. 21. On the first iteration of this loop, the next bit plane is the first bit plane. The process determines the zero-tree data word for the corresponding wavelet coefficient data word (processing block 606). This produces a corresponding descendant zero plane data word such as illustrates in FIG. 21 at 540. The process determines the coding for each bit as P (positive), N (negative), T (zero-tree node) or Z (isolate zero) (processing block 607). This determination was described in conjunction with FIG. 21. Note that this process requires tracking encoded P and N wavelet coefficients so that these will not be coded at lower thresholds and tracking descendant wavelet coefficients coded as part of a zero-tree. However, this process is known in the art and will not be further described. Next the process performs the refinement pass (processing block 608).

The process tests to determine if this wavelet coefficient data word was the last of the image (decision block 609). If not (No at decision block 609), then the process returns to block 605 to process the next data word. If this is the end of the image (Yes at decision block 609), the process tests to determine if the maximum amount of data to be encoded has been reached (decision block 610). If this is true (Yes at decision block 610), then the process exits at end block 612. If the maximum amount of data has not been encoded (No at decision block 610), then the process tests to determine if the current bit plane was the last bit plane (decision block 611). If the current bit plane was the last and least significant bit plane (Yes at decision block 611), then the all of the wavelet coefficients of the image have been encoded. The process exits at end block 612. If the current bit plane was not the last bit plane (No at decision block 611), then the process returns to processing block 604 to repeat with the next bit plane.

Planarizing the data opens up new avenues of optimization. Processing is many times faster than a traditional approach, with significantly less memory traffic. Less memory traffic leads to lower power and better system utilization. This invention makes large numbers of decisions in parallel on multibit data. The fundamental difference in this invention is the application of these techniques to multiple-bit data, transforming complex data-dependent sequences into efficient, fixed-time codes.

1. A method of embedded zero-tree wavelet encoding of image data comprising the steps of:
converting image data in pixel form into wavelet coefficients;
converting the wavelet coefficients into bit plane format packing a single bit plane for plural wavelet coefficients into a data word of a predetermined length;
determining if wavelet coefficients are greater than a threshold by determining whether a bit corresponding to said wavelet coefficient of a bit plane data word corresponding to said threshold is “1” or “0”;
encoding each wavelet coefficient dependent upon the results of said determination whether said wavelet coefficients is greater than said threshold.

2. The method of claim 1, wherein:
said step of determining if wavelet coefficients are greater than a threshold includes
determining whether a bit corresponding to each wavelet coefficient of a most significant bit plane data word is “1” or “0”,
determining whether a bit corresponding to each wavelet coefficient of a next most significant bit plane is “1” or “0”,
repeating said determining whether a bit corresponding to each wavelet coefficient of a next most significant bit plane for each bit plane until determining with a least significant bit plane.

3. The method of claim 2, wherein:
said step of determining if wavelet coefficients are greater than a threshold further includes
exiting before determination for each bit plane upon encoding more than a predetermined maximum amount of data.

4. The method of claim 2, further including the steps of:
for each bit plane data word determining whether all descendant wavelet coefficients of each wavelet coefficient represented in said bit plane data word are “0”; and
said step of encoding each wavelet coefficient includes encoding a wavelet coefficient as a zero-tree node if said bit of said bit plane data word is “0” and all descendant wavelet coefficients of said wavelet coefficient are “0”.

5. The method of claim 4, wherein:
said step of determining whether all descendant wavelet coefficients of each wavelet coefficient represented in said bit plane data word are “0” includes forming an AND of the corresponding bit of a current bit plane of all descendant wavelet coefficients.

6. The method of claim 4, wherein:
said wavelet coefficients are signed integers having a most significant bit indicative of sign; and
said step of encoding each wavelet coefficient encodes a wavelet coefficient as
P (positive) if the corresponding bit of the corresponding bit plane data word is “1” and the sign bit is “0”,
N (negative) if the corresponding bit of the corresponding bit plane data word is “1” and the sign bit is “1”,
T (zero-tree node) if the corresponding bit of the corresponding bit plane data word is “0” and all descendant wavelet coefficients of are “0”, and
Z (isolate zero) if the corresponding bit of the corresponding bit plane data word is “0” and not all descendant wavelet coefficients of are “0”.
